(19) United States
(12) Patent Application Publication
(10) Pub. No.: US 2008/0117654 A1
(43) Pub. Date: May 22, 2008

(54) Multi-output switching power supply having voltage limiting circuit

(75) Inventors: Huai-Zhu Yan, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/986,378

(22) Filed: Nov. 21, 2007

(30) Foreign Application Priority Data
Nov. 21, 2006 (TW) 95142996

(51) Int. Cl. H02M 3/335

(52) U.S. Cl. 363/21.01

(57) ABSTRACT

An exemplary multi-output switching power supply (2) includes: a switching power supply controller (21) for generating a pulse signal; a transformer device (20) for providing a first AC voltage and a second AC voltage according to the pulse signal; a first regulation circuit (23, 25) for transforming the first AC voltage into a first DC voltage; a second regulation circuit (24, 26) for transforming the second AC voltage into a second DC voltage; a first output (27) and a second output (28) for respectively providing the first DC voltage and second DC voltage to a heavy load and a light load; a sampling circuit and a feedback circuit configured for generating a feedback signal according to the first DC voltage and the second DC voltage and providing the feedback signal to the switching power supply controller, and a voltage limiting circuit (29) connected between the first and second outputs.

### FIELD OF THE INVENTION

The present invention relates to a multi-output switching power supply which can be used in an electronic device such as a liquid crystal display (LCD).

### GENERAL BACKGROUND

Multi-output switching power supplies have been widely used in all kinds of electronic devices. For example, the multi-output switching power supply is used on a main board of a computer or a notebook, or in a communication device, a mobile phone, or an LCD. A multi-output switching power supply typically includes a transformer, which provides power for a main output and at least one auxiliary output.

Referring to FIG. 3 and FIG. 4, a typical multi-output switching power supply 1 includes a transformer device 10, a switching power supply controller 11, a feedback circuit 12, a sampling circuit 19, a first half wave rectifier 13, a second half wave rectifier 14, a first filter circuit 15, a second filter circuit 16, a first output 17, and a second output 18.

The transformer device 10 includes a direct current (DC) power supply 101, a switching transistor 102, a primary winding 103, and a secondary winding 104. A control electrode 1021 of the switching transistor 102 is connected to the switching power supply controller 11 for receiving a pulse control signal. A first conducting electrode 1022 of the switching transistor 102 is connected to ground. A second conducting electrode 1023 of the switching transistor 102 is connected to one terminal of the primary winding 103. The other terminal of the primary winding 103 is connected to the DC power supply 101.

The secondary winding 104 includes a first terminal 1041 and a second terminal 1042. The first terminal 1041 of the secondary winding 104 is connected to the first output 17 via the first half wave rectifier 13 and the first filter circuit 15 in series. The second terminal 1042 of the secondary winding 104 is connected to the second output 18 via the second half wave rectifier 14 and the second filter circuit 16 in series.

The first half wave rectifier 13 includes a first branch circuit 131 having a resistor and a capacitor connected in series, and a first regulating diode 132 connected in parallel with the first branch circuit 131. A positive terminal of the first regulating diode 132 is connected to the first terminal 1041 of the secondary winding 104 of the transformer device 10. A negative terminal of the first regulating diode 132 is connected to the first filter circuit 15.

The second half wave rectifier 14 includes a second branch circuit 141 having a resistor and a capacitor connected in series, and a second regulating diode 142 connected in parallel with the second branch circuit 141. A positive terminal of the second regulating diode 142 is connected to the second terminal 1042 of the secondary winding 104 of the transformer device 10. A negative terminal of the second regulating diode 142 is connected to the second filter circuit 16.

The sampling circuit 19 includes a first sampling resistor 191, a second sampling resistor 192, a third sampling resistor 193, and a feedback tap 194. The first sampling resistor 191 is connected between the first output 17 and the feedback tap 194. The second sampling resistor 192 is connected between the second output 18 and the feedback tap 194. The third sampling resistor 193 is connected between the feedback tap 194 and ground.

The feedback circuit 12 includes an input terminal connected to the feedback tap 194 for receiving a sampling voltage from the feedback tap 194. The feedback circuit 12 generates a feedback signal according to the sampling voltage, and provides the feedback signal to the switching power supply controller 11.

The switching power supply controller 11 is configured to generate the pulse control signal for switching on and switching off the switching transistor 102 of the transformer device 10, and to adjust a duty ratio of the pulse control signal according to the received feedback signal. When the switching transistor 102 is switched on, magnetic energy is stored in the primary winding 103. When the switching transistor 102 is switched off, the magnetic energy stored in the primary winding 103 is transferred to the secondary winding 104. Therefore a first alternating current (AC) voltage is generated at a first terminal 1041 of the secondary winding 104, and a second AC voltage is generated at a second terminal 1042 of the secondary winding 104. The first AC voltage is transformed into a first DC voltage via the first half wave rectifier 13 and the first filter circuit 15 in series, and the first DC voltage is provided to the first output 17. The second AC voltage is transformed into a second DC voltage via the second half wave rectifier 14 and the second filter circuit 16 in series, and the second DC voltage is provided to the second output 18. The first DC voltage is lower than the second DC voltage. For example, the first DC voltage and the second DC voltage can be equal to 5 volts (V) and 12V, respectively.

In one exemplary application, when a heavy load (not shown) and a light load (not shown) are respectively connected to the first output 17 and the second output 18, the 5V voltage at the first output 17 for driving the heavy load is decreased to 4V, and the 12V voltage at the second output 18 provided to the light load remains at 12V. Thus the feedback circuit 12 generates a first feedback signal according to a voltage that is less than 2.5V at the feedback tap 194, and provides the first feedback signal to the switching power supply controller 11. The switching power supply controller 11 increases the duty ratio of the pulse control signal according to the received first feedback signal. Therefore a period in which the switching transistor 102 of the transformer device 10 remains in an activated state is prolonged, and the voltages respectively at the first output 17 and the second output 18 are increased.

Because the light load is connected to the second output 18, the voltage at the second output 18 quickly increases to 28V. Because the heavy load circuit is connected to the first output 17, the voltage at the first output 17 increases to approximately 4.5V. Thus the feedback circuit 12 generates a second feedback signal according to a voltage that is equal to 2.5V at the feedback tap 194, and provides the second feedback signal to the switching power supply controller 11. The switching power supply, controller 11 maintains the duty ratio of the pulse control signal according to the received second feedback signal. Therefore, the voltages at the first output 17 and the second output 18 remain at 4.5V and 28V respectively.

However, the heavy load normally includes a number of integrated circuits (ICs) which generally only work when the 5V operation voltage is provided. Thus an electronic device such as an LCD using the multi-output switching power supply 1 is liable to operate wrongly because of the insufficient voltage at the second output 18.

It is desired to provide a new multi-output switching power supply for use in an electronic device such as an LCD which can overcome the above-described deficiencies.

### SUMMARY

In one preferred embodiment, a multi-output switching power supply includes a switching power supply controller configured for generating a pulse signal; a transformer device configured for receiving the pulse signal and generating a first AC voltage and a second AC voltage according to the received pulse signal; a first half wave rectifier and a first filter circuit connected in series for transforming the first AC voltage into a first DC voltage; a second half wave rectifier and a second filter circuit connected in series for transforming the second AC voltage into a second DC voltage; a first output configured for receiving the first DC voltage and providing the first DC voltage to a heavy load; a second output configured for receiving the second DC voltage and providing the second DC voltage to a light load; a voltage limiting circuit connected between the first output and second output; a sampling circuit connected between the first, second output and ground for generating a feedback voltage according to the first and second DC voltages; and a feedback circuit configured for generating a feedback signal according to the feedback voltage and providing the feedback signal to the switching power supply controller.

Other novel features and advantages will become more apparent from the following detailed description when taken in conjunction with the accompanying drawings.

### BRIEF DESCRIPTION OF THE DRAWINGS

FIG. 1 is a circuit diagram of a multi-output switching power supply according to an exemplary embodiment of the present invention, the multi-output switching power supply including a transformer device.

FIG. 2 is a circuit diagram of the transformer device of FIG. 1.

FIG. 3 is a circuit diagram of a conventional multi-output switching power supply used in an LCD, the multi-output switching power supply including a transformer device.

FIG. 4 is a circuit diagram of the transformer device of FIG. 3.

### DETAILED DESCRIPTION OF PREFERRED EMBODIMENTS

Reference will now be made to the drawings to describe various embodiments of the present invention in detail.

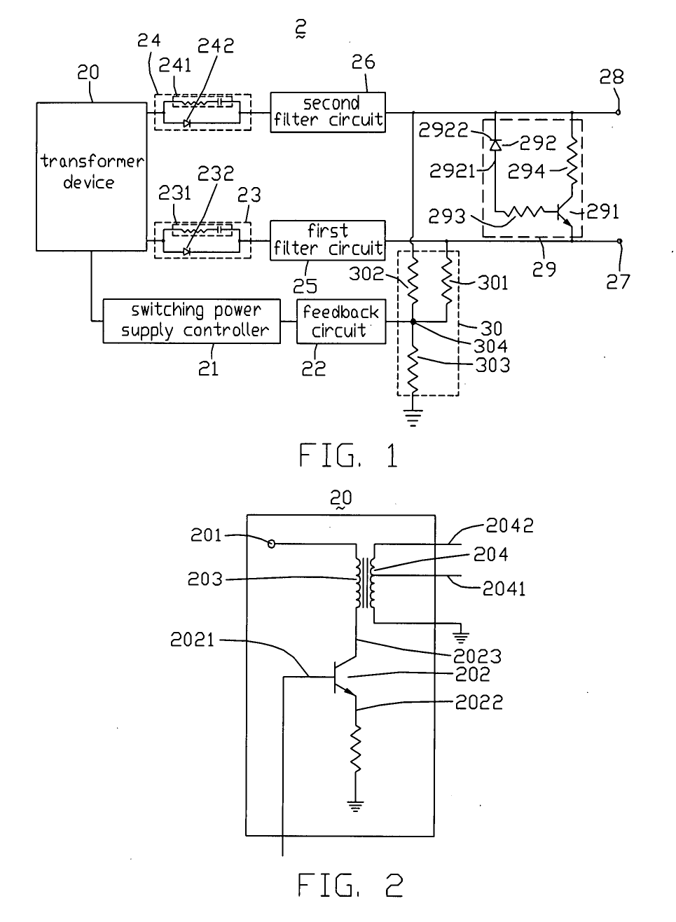

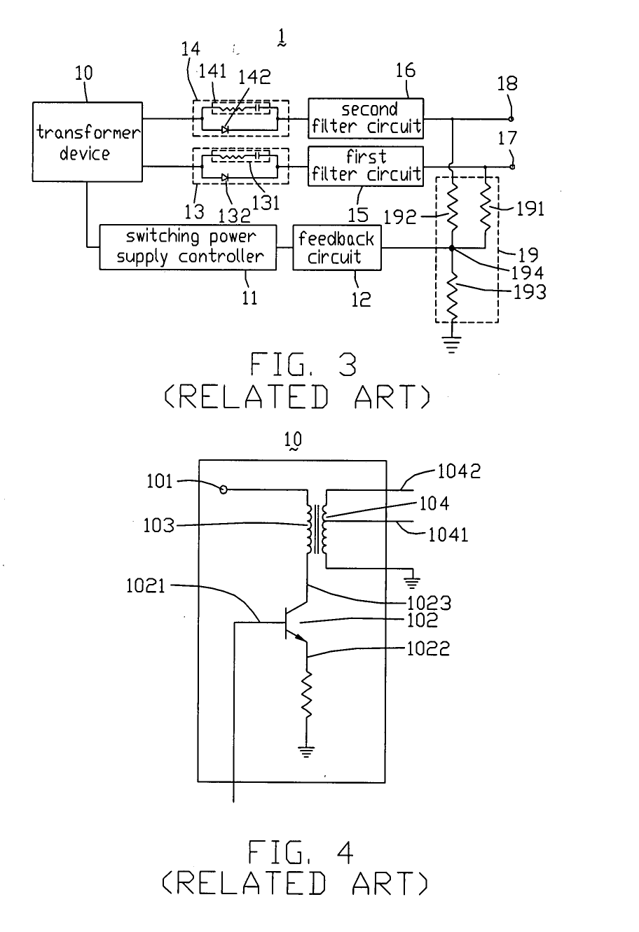

Referring to FIG. 1 and FIG. 2, a multi-output switching power supply 2 according to an exemplary embodiment of the present invention is shown. The multi-output switching power supply 2 includes a transformer device 20, a switching power supply controller 21, a feedback circuit 22, a first half wave rectifier 23, a second half wave rectifier 24, a first filter circuit 25, a second filter circuit 26, a first output 27, and a second output 28.

The transformer device 20 includes a DC power supply 201, a switching transistor 202, a primary winding 203, and a secondary winding 204. A control electrode 2021 of the switching transistor 202 is connected to the switching power supply controller 21 for receiving a pulse control signal. A first conducting electrode 2022 of the switching transistor 202 is connected to ground. A second conducting electrode 2023 of the switching transistor 202 is connected to a terminal of the primary winding 203. The other terminal of the primary winding 203 is connected to the DC power supply 201.

The secondary winding includes a first terminal (not labeled) and a second terminal (not labeled). The first terminal 2041 of the secondary winding 204 is connected to the first output 27 via the first half wave rectifier 23 and the first filter circuit 25 in series. The second terminal 2042 of the secondary winding 204 is connected to the second output 28 via the second half wave rectifier 24 and the second filter circuit 26 in series.

The first half wave rectifier 23 includes a first branch circuit 231 having a first resistor (not labeled) and a capacitor (not labeled) connected in series, and a first regulating diode 232 connected in parallel with the first branch circuit 231. A positive terminal of the first regulating diode 232 is connected to the first terminal 2041 of the secondary winding 204 of the transformer device 20. A negative terminal of the first regulating diode 232 is connected to the first filter circuit 25. The first half wave rectifier 23 and the first filter circuit 25 in combination can be considered as a first regulation circuit.

The second half wave rectifier 24 includes a second branch circuit 241 having a second resistor (not labeled) and a capacitor (not labeled) connected in series, and a second regulating diode 242 connected in parallel with the second branch circuit 241. A positive terminal of the second regulating diode 242 is connected to the second terminal 2042 of the secondary winding 204 of the transformer device 20. A negative terminal of the second regulating diode 242 is connected to the second filter circuit 26. The second half wave rectifier 24 and the second filter circuit 26 in combination can be considered as a second regulation circuit.

The voltage limiting circuit 29 includes a transistor 291, a clamping diode 292, a third resistor 293, and a fourth resistor 294. A base electrode of the transistor 291 is connected to a negative electrode 2921 of the clamping diode 292 via the third resistor 293. A positive electrode 2922 of the clamping diode 292 is connected to the second output 28. An emitter electrode of transistor 291 is connected to ground. A collector electrode of the transistor 291 is connected to the second output 28 via the fourth resistor 294. A resistance of the fourth resistor 294 is approximately equal to 100 ohms (Ω). A resistance of the third resistor 293 is approximately equal to 200Ω. The transistor 291 is a negative-positive-negative transistor or an n-channel enhancement mode metal-oxide-semiconductor transistor.

The sampling circuit 30 includes a first sampling resistor 301, a second sampling resistor 302, a third sampling resistor 303, and a feedback tap 304. The first sampling resistor 301 is connected between the first output 27 and the feedback tap 304. The second sampling resistor 302 is connected between the second output 28 and the feedback tap 304. The third sampling resistor 303 is connected between the feedback tap 304 and ground. A resistance of the first sampling resistor 301 is approximately equal to 12 kiloohms (KΩ). A resistance of the second sampling resistor 302 is approximately equal to 91 KΩ. A resistance of the third sampling resistor 303 is approximately equal to 8 KΩ.

The feedback circuit 22 includes an input terminal connected to the feedback tap 304 for receiving a sampling voltage from the feedback tap 304. The feedback circuit 22 generates a feedback signal according to the sampling voltage, and provides the feedback signal to the switching power supply controller 21.

The switching power supply controller 21 is configured to generate the pulse control signal for switching on and switching off the switching transistor 202, and to adjust a duty ratio of the pulse control signal according to the received feedback signal. When the switching transistor 202 is switched on, magnetic energy is stored in the primary winding 203. When the switching transistor 202 is switched off, the magnetic energy stored in the primary winding 203 is transferred to the secondary winding 204. Therefore a first AC voltage is generated at a first terminal 2041 of the secondary winding 204, and a second AC voltage is generated at a second terminal 2042 of the secondary winding 204.

The first AC voltage is transformed into a first DC voltage via the first half wave rectifier 23 and the first filter circuit 25 in series, and the first DC voltage is provided to the first output 27. The second AC voltage is transformed into a second DC voltage via the second half wave rectifier 24 and the second filter circuit 26 in series, and the second DC voltage is provided to the second output 28. The first DC voltage is lower than the second DC voltage. For example, the first DC voltage and the second DC voltage can be equal to 5V and 12V, respectively.

In one exemplary application, a heavy load and a light load (not shown) are respectively connected to the first output 27 and the second output 28. The 5V voltage at the first output 27 for driving the heavy load is decreased to approximately 4V. The 12V voltage at the second output 28 for driving the light load remains at 12V. Thus the feedback circuit 12 generates a first feedback signal according to a first sampling voltage which is less than 2.5V at the feedback tap 304, and provides the first feedback signal to the switching power supply controller 21. The switching power supply controller 21 increases the duty ratio of the pulse control signal according to the received first feedback signal. Therefore a period in which the switching transistor 202 of the transformer device 20 remains in an activated state is prolonged, and the voltages at the first output 27 and the second output 28 are both increased.

When the voltage at the second output 28 is increased to approximately 22V, a voltage crossing the clamping diode 292 makes the clamping diode 292 conduct current in a reverse direction. The transistor 291 is then turned on, and the fourth resistor 294 becomes a load connected between the first output 27 and the second output 28. Thus the voltage at the second output 28 is decreased from 22V to 18V. At the same time, the voltage at the first output 27 increases to approximately 4.5V. The feedback circuit 22 generates a second feedback signal according to a second sampling voltage that is less than 2.5V at the feedback tap 304, and provides the second feedback signal to the switching power supply controller 21. The switching power supply controller 21 continues to increase the duty ratio of the pulse control signal according to the received second feedback signal until a voltage at the first output 27 is approximately equal to 5V. The heavy load typically includes a number of ICs which generally only work when a 5V operation voltage is provided. Thus, the heavy load having the ICs can work normally when the 5V operation voltage is provided.

Because the the multi-output switching power supply 2 includes the voltage limiting circuit 29, the multi-output switching power supply 2 can reliably output the desired 5V DC voltage to the first output 27.

In various alternative embodiments, the multi-output switching power supply 2 can include more than two outputs for providing voltages to corresponding loads and/or load circuits.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A multi-output switching power supply comprising:
a switching power supply controller configured for generating a pulse signal;
a transformer device configured for receiving the pulse signal and generating a first alternating current (AC) voltage and a second AC voltage according to the received pulse signal;
a first half wave rectifier and a first filter circuit connected in series for transforming the first AC voltage into a first direct current (DC) voltage;
a second half wave rectifier and a second filter circuit connected in series for transforming the second AC voltage into a second DC voltage;
a first output configured for receiving the first DC voltage and providing the first DC voltage to a heavy load;
a second output configured for receiving the second DC voltage and providing the second DC voltage to a light load;
a voltage limiting circuit connected between the first output and the second output;
a sampling circuit connected between the first and second outputs and ground, and configured for generating a feedback voltage according to the first and second DC voltages; and
a feedback circuit configured for generating a feedback signal according to the feedback voltage, and providing the feedback signal to the switching power supply controller.

2. The multi-output switching power supply as claimed in claim 1, wherein the first half wave rectifier comprises a first branch circuit and a first regulating diode connected in parallel with the first branch circuit, a positive terminal of the first regulating diode being connected to a first terminal of the transformer device, and a negative terminal of the first regulating diode being connected to the first filter circuit.

3. The multi-output switching power supply as claimed in claim 2, wherein the first branch circuit comprises a first resistor and a capacitor connected in series.

4. The multi-output switching power supply as claimed in claim 1, wherein second half wave rectifier comprises a second branch circuit and a second regulating diode connected in parallel with the second branch circuit, a positive terminal of the second regulating diode being connected to a second terminal of the transformer device, and a negative terminal of the second regulating diode being connected to the second filter circuit.

5. The multi-output switching power supply as claimed in claim 4, wherein the second branch circuit comprises a second resistor and a capacitor connected in series.

6. The multi-output switching power supply as claimed in claim 1, wherein the voltage limiting circuit comprises a transistor, a clamping diode, a third resistor, and a fourth resistor, a base electrode of the transistor being connected to the second output via the third resistor and the clamping diode in series, a negative electrode of the clamping diode being connected to the second output, an emitter electrode of the transistor being connected to ground, and a collector electrode of the transistor being connected to the second output via the fourth resistor.

7. The multi-output switching power supply as claimed in claim 6, wherein a resistance of the third resistor is approximately equal to 200Ω.

8. The multi-output switching power supply as claimed in claim 6, wherein a resistance of the fourth resistor is approximately equal to 100Ω.

9. The multi-output switching power supply as claimed in claim 6, wherein the transistor is one of a negative-positive-negative transistor and an n-channel enhancement mode metal-oxide-semiconductor transistor.

10. The multi-output switching power supply as claimed in claim 1, wherein the sampling circuit comprises a first sampling resistor, a second sampling resistor, a third sampling resistor, and a feedback tap, the first sampling resistor being connected between the first output and the feedback tap, the second sampling resistor being connected between the second output and the feedback tap, and the third sampling resistor being connected between the feedback tap and ground.

11. The multi-output switching power supply as claimed in claim 10, wherein the feedback circuit comprises an input terminal connected to the feedback tap for receiving the feedback voltage, and an output terminal for providing the feedback signal to the switching power supply controller.

12. The multi-output switching power supply as claimed in claim 1, wherein the transformer device comprises a DC power supply, a switching transistor, a primary winding, and a secondary winding.

13. A multi-output switching power supply comprising:
a first output configured for providing a first direct current (DC) voltage to a heavy load;
a second output configured for providing a second DC voltage to a light load; and
a voltage limiting circuit connected between the first output and the second output, for preventing one of the DC voltages from exceeding a predetermined reference voltage.

14. The multi-output switching power supply as claimed in claim 13, wherein the voltage limiting circuit comprises a transistor, a clamping diode, a third resistor, and a fourth resistor, a base electrode of the transistor being connected to the second output via the third resistor and the clamping diode in series, a negative electrode of the clamping diode being connected to the second output, an emitter electrode of the transistor being connected to ground, and a collector electrode of the transistor being connected to the second output via the fourth resistor.

15. The multi-output switching power supply as claimed in claim 14, wherein a resistance of the third resistor is approximately equal to 200Ω.

16. The multi-output switching power supply as claimed in claim 14, wherein a resistance of the fourth resistor is approximately equal to 100Ω.

17. The multi-output switching power supply as claimed in claim 14, wherein the transistor is one of a negative-positive-negative transistor and an n-channel enhancement mode metal-oxide-semiconductor transistor.
